(19) United States
(12) Patent Application Publication
(10) Pub. No.: US 2023/0381824 A1
(43) Pub. Date: Nov. 30, 2023

(54) AUTOMATED SEGREGATION UNIT

(71) Applicant: SHITVA ROBOTIC SYSTEMS PVT LTD, Ahmedabad (IN)

(72) Inventor: JITESH DADLANI, Ahmedabad (IN)

(73) Assignee: SHITVA ROBOTIC SYSTEMS PVT LTD, Ahmedabad, GJ (IN)

(21) Appl. No.: 18/248,874

(22) PCT Filed: Oct. 13, 2021
(86) PCT No.: PCT/IN2021/050981

§ 371 Date: Apr. 13, 2023

(30) Foreign Application Priority Data
Oct. 14, 2020 (IN) 202021044745

(51) Int. Cl. B07C 5/342; B07C 5/36; B07C 5/10

(52) U.S. Cl. CPC B07C 5/342; B07C 5/363; B07C 5/10; B07C 2501/0054

(57) ABSTRACT

The present invention discloses an automated segregation unit including one or more feeders, one or more optical decision makers, one or more optical sorters, a plurality of storage units. A plurality of transport means operationally couples the said components. The optical decision maker is integrated with a first vision system configured to categorize one or more materials present in a stream of mixed objects on the basis of one or more identity parameters. The optical sorter configured to physically segregate the categorized one or more materials from the stream of mixed objects. The one or more optical decision makers instructs the one or more optical sorters to eject one or more category of segregated objects to its respective storage unit. A method of operating the automated segregation unit is also disclosed in the present invention.

### FIELD OF INVENTION

The present invention relates to a segregation unit. More specifically, the present invention relates to an automated segregation unit.

### BACKGROUND

A materials recovery facility (MRF) is a specialized plant that receives, separates and prepares recyclable materials for end-user manufacturers/recyclers. The MRF plant accepts a mixed solid waste stream and then proceeds to separate the designated recyclable materials through a combination of manual and mechanical sorting. The sorted recyclable materials may undergo further required processing to meet technical specifications established by end-markets.

However, the conventional MRF plants are non-automated or semi-automated systems that require intensive human labor and interventions at various levels for smooth operation. For example, considering the fact that the type of wastes in the solid waste stream may change on a day to day, or even minute to minute basis, a user has to physically adjust the components of the system accordingly to segregate the waste. Such an arrangement compromises the feasibility as well as efficiency of the operation.

Moreover, the conventional systems mostly segregate waste depending upon a single criterion such as chemical or physical properties (for example, polymer of waste item), size of the waste, weight of the waste, etc. The conventional systems generally deploy equipment that separate only a single material from the solid waste stream at any given time period. This leads to extended operation time due to multiple segregation of items in a linear way, hence operation of such systems may extend from several hours to days. To minimize the time, one has to invest heavily on increasing the plant size. However, the gains to handle high volume of waste along with sorting with higher accuracy remains inefficient. Also, such systems may ignore any residual material having economic value thus, making the whole process inefficient.

Further, the conventional MRF plants fail to prioritize the material to be segregated based on the change in composition of the mixed waste in real time.

Patent publication no. U.S. Pat. No. 8,393,558B2 discloses a system for mechanized separation and recovery of solid waste. However, the disclosed system depends upon a presorting conveyor where manual labor identifies items to be pre-sorted. Further, the said system fails to identify and categorize all the waste materials present in the waste stream for their subsequent separation based on the ever changing composition of the waste stream which leads to an inefficient process.

Therefore, there arises a requirement of segregation unit which overcomes the aforementioned challenges associated with the conventional waste segregation unit.

### SUMMARY

The present invention relates to an automated segregation unit, including one or more feeders to receive a stream of mixed objects to be segregated by the unit, one or more optical decision makers which controls the unit, one or more optical sorters functionally coupled to the optical decision maker, a plurality of storage units to collect respective categories of segregated objects. The unit also includes a plurality of transport means operationally coupled to the one or more feeders, one or more optical decision makers, one or more optical sorters and the plurality of storage units for transporting at least one of the one or more materials and/or segregated objects between each other. The optical decision maker is integrated with a first vision system configured to categorize one or more materials present in the stream of mixed objects on the basis of one or more identity parameters. The optical sorter configured to physically segregate the categorized one or more materials from the stream of mixed objects. The one or more optical decision makers instructs the one or more optical sorters to eject one or more category of segregated objects to its respective storage unit.

The present invention further discloses a method of operating the automated segregation unit. The method includes scanning a stream of mixed objects by one or more optical decision maker; categorizing the mixed objects by the optical decision maker based upon one or more predefined identity parameters; prioritizing the categorized objects by the optical decision maker based upon one or more predefined priority parameter; instructing one or more optical sorter to eject the prioritized objects, the instruction being communicated by the optical decision maker; ejecting each category of objects from the stream of mixed objects by at least one ejection means; and collecting respective categories of ejected objects by a plurality of storage units.

The present invention discloses another method of operating the automated segregation unit. The method includes scanning a stream of mixed objects by one or more optical decision maker; categorizing the mixed objects by the optical decision maker based upon one or more predefined identity parameters; prioritizing the categorized objects by the optical decision maker based upon one or more predefined priority parameter; instructing one or more optical sorter to eject the prioritized and categorized objects, the instruction being communicated by the optical decision maker; ejecting one or more category of objects from the stream of mixed objects by at least one ejection means; collecting respective categories of ejected objects by a plurality of storage units; and looping remaining category of objects via a plurality of transport means to eject the remaining category of objects in the plurality of storage units.

The foregoing features and other features as well as the advantages of the invention will become more apparent from the following detailed description, which proceeds with reference to the accompanying figures.

### BRIEF DESCRIPTION OF DRAWINGS

The summary above, as well as the following detailed description of illustrative embodiments, is better understood when read in conjunction with the apportioned drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale.

FIG. 1 depicts an automated segregation unit 100 in accordance with an embodiment of the present invention.

FIG. 1a depicts a method of operation for the automated segregation unit 100 in accordance with an embodiment of the present invention.

FIG. 2 depicts an alternate embodiment of the automated segregation unit 100a in accordance with an embodiment of the present invention.

FIG. 3 depicts another embodiment of the automated segregation unit 100b in accordance with an embodiment of the present invention.

FIG. 4 depicts yet another embodiment of the automated segregation unit 100c of the automated segregation unit 100b of FIG. 3 in accordance with an embodiment of the present invention.

FIG. 5 depicts yet another embodiment of two automated segregation unit 100d in accordance with an embodiment of the present invention.

### DETAILED DESCRIPTION OF THE DRAWINGS

Prior to describing the invention in detail, definitions of certain words or phrases used throughout this patent document will be defined: the terms “include” and “comprise”, as well as derivatives, mean inclusion without limitation; the term “or” is inclusive, meaning and/or; Definitions of certain words and phrases are provided throughout this patent document, and those of ordinary skill in the art will understand that such definitions apply in many, if not most, instances to prior as well as future uses of such defined words and phrases.

Wherever possible, same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Particular embodiments of the present disclosure are described herein below with reference to the accompanying drawings, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

In accordance with the present disclosure, an automated segregation unit (or automated waste segregation unit) is disclosed.

The automated segregation unit described below is utilized for segregation of a plurality of objects based upon a predefined criteria. It should be noted that though the objects may include any object known in the art, for exemplary purposes, the below description discloses the automated segregation unit of the present invention to be applied for segregating a mixed waste stream.

The term ‘mixed waste stream’ in the below description corresponds to a heterogeneous or homogeneous waste stream having economic and commercial value. The mixed waste stream includes a mixture of different types of wastes as received from a pre-defined waste generation source. The different types of waste may include but not limited to plastic, paper, films, glass, rubber, metal, electronic waste, etc.

The term ‘residual waste stream’ corresponds to a mixed waste stream from which at least one recyclable material has been removed.

The term ‘rejected waste stream’ relates to a waste stream having non-recyclable materials and/or a waste stream having materials which need not be of any interest to the operator/user of the present invention.

It should be noted that the terms such as, “recoverable”, “recovered”, “recyclable”, “recycled”, “reusable”, and “reused” used in the following specification, all refer to a solid waste material that has a potential economic and/or commercial value or use.

The automated segregation unit of the present invention is a fully automated system which is capable of sorting/segregating one or more recyclable materials from a mixed waste stream. The automated segregation unit is configured to automatically segregate different categories of recyclable materials from the mixed waste stream in a sequential manner until and unless a residual and/or rejected waste stream is obtained. Hence, all the decisions and controls of the automated segregation unit for segregating recyclable materials from the mixed waste stream are internally regulated by the automated segregation unit which requires minimal to zero human intervention.

Although, the present invention is described with examples of solid mixed waste, as mentioned above, the teachings of the present invention may be applied for segregating a plurality of objects in various settings such as but not limited to food industry, mining industry, manufacturing plants, recycling industry, etc. In the following description, the plurality of objects is analogous to solid waste.

Further, the automated segregation unit of the present invention is capable of segregating high volumes of multiple categories of recyclable materials from the mixed waste stream at a given time period. Such an arrangement reduces the time for segregation of recyclable materials to a considerable extent.

The automated segregation unit performs dynamic segregation of recyclables based upon a pre-defined logic which is automatically updated in real-time based upon the constituents of mixed waste stream. In order to perform dynamic segregation, the automated segregation unit of the present invention includes various components that are operatively coupled to each other. The components include one or more of, a feeder, a transport means, an optical decision maker, an optical sorter, and a storage unit/bin, etc.

The automation in the automated segregation unit is mediated by the optical decision maker and/or the optical sorter. The optical decision maker and the optical sorter of the present invention are provided with a vision system. The vision system scans the mixed waste stream in real-time. The optical decision maker then categorizes the recyclable materials in different classifiers based upon a pre-defined criteria and/or end user's requirement. The optical decision maker also sets a priority of ejection of the categorized recyclable materials either based on user's preference or ratio of different materials present on the transport means at any given time. For example, the optical decision maker may decide to eject the materials in decreasing and/or increasing order of their abundance in the mixed waste stream. The optical decision maker transmits the inputs (for example, the priority of ejection of the categorized recyclable material) as instructions to the optical sorter(s). In an embodiment, the optical sorter(s) identifies the prioritized category of recyclable material on the basis of the inputs received from the optical decision maker and accordingly controls the ejection of the recyclable materials towards a pre-selected storage unit. In an alternate embodiment, the optical sorter(s) may rely on the optical decision maker to identify the prioritized category of recyclable material and thereafter enable the optical decision maker to accordingly control the ejection of the recyclable materials towards the pre-selected storage unit. In another alternate embodiment, when material belonging to only one classifier is required to be segregated, the optical sorter may eject the recyclable material without relying on any inputs from the optical decision maker. The optical sorter also governs the collection of the ejected recyclable material into the designated storage units.

In an embodiment, the waste segregation unit is a completely automated system. In an alternate embodiment, the waste segregation unit is an automated system with a provision for displaying one or more prompts for the user inputs. Based upon user inputs to said prompts, the automatic segregation unit may make and/or override one or more pre-configured decisions. The prompts may be pre-configured and/or can be configured during operating the segregation unit of the present invention. The prompts may be displayed on a screen associated with an input means. The input means may be any human interface device (HID) capable of accepting user inputs.

The above disclosed automatic segregation unit is described in detail with the help of figures below.

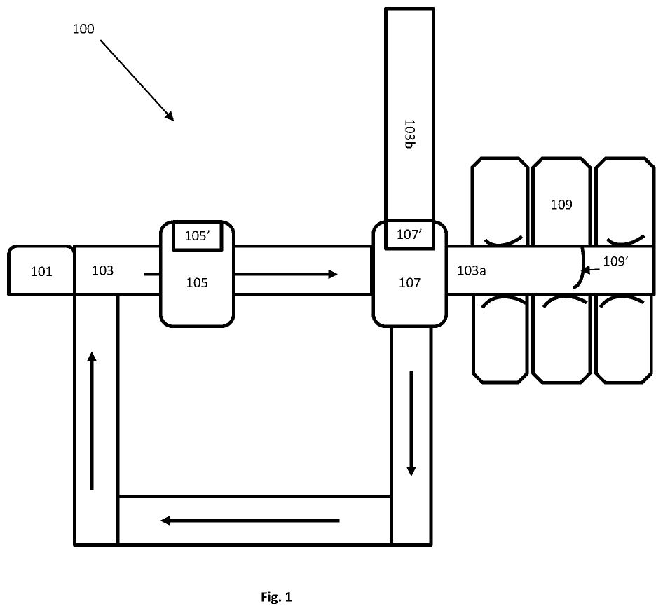

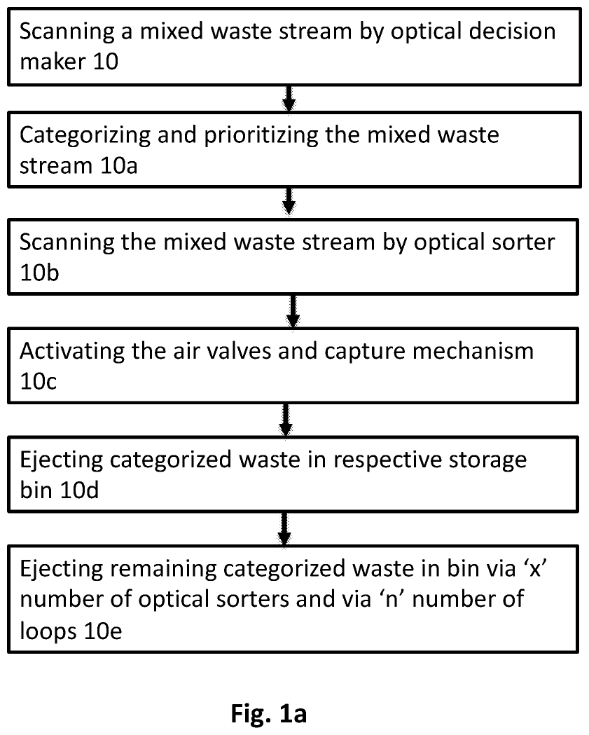

Referring to figures, FIG. 1 depicts an exemplary embodiment of an automated segregation unit 100 (or unit 100). The unit 100 is equipped to receive a mixed waste stream and segregate one or more recyclable materials from non-recyclable waste present in the mixed waste stream. The unit 100 may be specialized to segregate a certain type of waste from the mixed waste stream only. In such cases, the unit 100 may segregate at least one recyclable material and produce a reject waste stream including recyclable materials and/or non-recyclable materials which cannot be processed by the unit 100. Alternately, the unit 100 is equipped to segregate all types of waste from the mixed waste stream. In such cases, after segregating all the recyclable material, the unit 100 may produce a reject waste stream which includes only non-recyclable materials which may be sent to a disposal facility. In an embodiment of the present invention, the automated segregation unit 100 is equipped to segregate all types of waste from the mixed waste stream.

The mixed waste stream may include waste from a pre-defined source such as a municipality, a residential and/or a commercial/industrial setting. The mixed waste may include a heterogeneous or homogeneous mixture for example, containing various solid recyclable dry waste. The solid recyclable dry waste may include materials of interest to the end user such as without limitation, plastic cans, PET (Polyethylene terephthalate) bottles, HDPE (High-density polyethylene) bottle, PP (Polypropylene), LDPE (Low-density polyethylene), paper, cardboard, glass bottles, metal-ferrous and non-ferrous (zinc, copper, aluminum, bronze, steel), etc.

The components of the automated segregation unit 100 may include without limitation one or more of a feeder 101, a plurality of transport means 103, one or more of an optical decision maker 105, one or more of an optical sorter 107 and a plurality of storage units 109. The aforesaid components may operate in a synchronized manner to segregate recyclable materials from the mixed waste stream in a fully automated manner.

The feeder 101 may act as a receiver for receiving the mixed waste dumped by a user for segregation. The feeder 101 may have a pre-defined holding and/or processing capacity to hold and/or process the mixed waste. The holding and/or processing capacity of the feeder 101 may be dependent upon a plant size (per hour waste processing capacity).

A per day waste processing capacity may be defined as the quantity of mixed waste that can be segregated by the unit 100 in a given day. The per day waste processing capacity of the unit 100 may range between 1 to 1000 metric tons per day. However, the automated segregation unit 100 can be scaled up and/or down by a person skilled in the art according to the per day waste processing capacity of the unit 100.

The per hour waste processing capacity of the unit 100 is derived by dividing the per day waste processing capacity by total hour of operation of the unit 100 in a day. In an exemplary embodiment, unit 100 having daily waste processing capacity of 5 metric ton per day is operated for 10 hours a day, will have waste processing capacity of 0.5 metric ton per hour.

The feeder 101 may be any conventionally used structure known in the art including a closed/open storage box, an open strip/platform, vibrating feeder, ballistic separator, trommel, conveyor feeder, drum feeder, ballastic separator, magnetic separator, eddy current separator or a combination thereof. The feeder 101 may help in pre-processing the mixed waste by means of 2D and/or 3D separation. The feeder 101 may also include a feeding rate which is defined as the amount of mixed waste being fed into the unit 100 per unit time. In an embodiment, the feeder 101 is in the form of an open box having pre-defined dimensions followed by a drum feeder with an adjustable rotation speed corresponding to the feeding rate.

In an exemplary embodiment, the unit 100 prompts the user to select a feeding rate of the feeder 101.

The feeder 101 is made of a conventionally known material which is durable and non-reactive. The material may include without limitation metals, alloys, etc. In an embodiment, the feeder(s) 101 may be made of mild steel alloy.

The number of feeders 101 present in the unit 100 may vary based upon the per day waste processing capacity of the unit 100. In an embodiment, the automated segregation unit 100 includes one feeder 101 for feeding the automated segregation unit 100 with the mixed waste. In an alternate embodiment, the automated segregation unit 100 includes three feeders 101 for feeding the automated segregation unit 100 with the mixed waste.

The transport means may be operationally coupled to the one or more feeders 101, one or more optical decision makers 105, one or more optical sorters 107 and a plurality of storage units 109. The transport means 103 is structured to receive the mixed waste from the feeder(s) 101 and transports it from one location to another for segregation. The transport means 103 of the automated segregation unit 100 may be any conventional transport means 103 known in the art that is capable of carrying one or more materials from one point to another. In an embodiment of the present invention, the transport means 103 includes one or more conveyor belts. The transport means 103 helps to carry and transport at least one of, the recyclable materials, the mixed waste stream, a residual waste stream, a rejected waste stream and/or segregated waste from one location to another. The number of transport means 103 may vary. For example, a first transport means 103 may transport the mixed waste stream from the feeder 101 to the optical sorter 107. A second transport means 103a may transport the recyclable materials from the optical sorter 107 to the storage unit 109. A third transport means (not shown) may transport the residual waste stream from one optical sorter 107 to another optical sorter (not shown). A fourth transport means 103b may transport the rejected waste stream from the optical sorter 107 to a dumping unit (not shown). It should be noted that alternate embodiments of the transport means 103 are also within the scope of the present invention.

The transport means 103 may transport the recyclable materials, the mixed waste stream, the residual waste stream and/or the rejected waste stream at a pre-defined transport rate. The transport rate corresponds to the amount of waste that is transported per unit time from one location to other location. The transport rate of the transport means 103 may be controllable or non-controllable. In an embodiment, the transport rate of the transport means 103 is internally controlled by the unit 100. Alternately, the unit 100 may prompt the user to select the transport rate.

Further, in an embodiment, in case of multiple transport means 103, all the transport means 103 may include same transport rate. Alternately, the transport rate of each transport means 103 may be different. The transport rate of each of the transport means 103 may be independently controlled internally by the unit 100 or by the user in an alternate embodiment based upon density and/or volume per unit area of the mixed waste present on the transport means 103.

The transport means 103 may be driven by a driving unit. The driving unit may be any conventional unit known in the art such as without limitation, a motor. Further, in case of multiple transport means 103, each transport means 103 includes a separate driving means. Alternately, all the transport means 103 may be driven by a single driving means. The driving means may be operatively coupled to the optical decision maker 105 and/or optical sorter 107. In an embodiment, the driving means is operatively coupled to the optical decision maker 105.

The transport means 103 may be provided with a plurality of feedback sensors (not shown). The feedback sensors may include without limitation distance/proximity, laser, ultrasonic, load or 2D/3D camera, etc. The feedback sensors may be operatively coupled to the transport means 103. In an embodiment, the feedback sensors are equidistantly disposed over the transport means 103. Alternately, the feedback sensors may be randomly disposed over the transport means 103. The feedback sensors may include but not limited to optical sensors/cameras (Near infrared sensors, X-ray sensors, Red Green Blue (RGB) visible spectrum/hyperspectral/spectral sensors, etc.), non-optical sensors or a combination thereof. In an embodiment, the transport means 103 includes a plurality of Internet of Things (IoT) feedback sensors that are uniformly disposed along the length of the transport means 103 at a distance of for example, 10 meters from each other.

The feedback sensors sense the amount (average depth of the material present over the transport means 103 at a given time point) and density of material carried by the transport means 103. Detection of other parameters to estimate the presence of material over the transport means 103 are also within the scope of the present invention. The feedback sensors also detect any damage to the transport means 103 as detailed below. Hence, the purpose of providing the said feedback sensors is to ensure smooth functioning of the transport means 103 and to ensure that the transport means 103 remains uncluttered and damage free.

In fact, the feedback sensors may be disposed at various locations of the automated segregation unit 100 apart from the transport means 103. The feedback sensors may provide the optical decision maker 105 and/or optical sorter 107 with digital data from various components of the automated segregation unit 100. The optical decision maker 105 may take necessary actions based upon the data given by the feedback sensors to ensure smooth and proper functioning of the automated segregation unit 100. The necessary actions may include but not limited to controlling the transport rate, etc. Therefore, in case of any malfunction, the user is not required to manually identify the cause and switch off the entire plant.

The optical decision maker 105 of the present invention acts as a controller of the automated segregation unit 100. The mixed waste stream is segregated by the unit 100 based upon the instructions of the optical decision maker 105. The optical decision maker 105 may be operatively coupled to other components of the automated segregation unit 100. For example, the optical decision maker 105 may be coupled to the feeder(s) 101, the transport means 103, the optical sorter(s) 107 and the storage units 109. In embodiment, the optical decision maker 105 controls the transport rate of the transport means 103 based upon density and/or volume per unit area of the mixed waste present on the transport means 103.

In addition to the above, the optical decision maker 105 may be operatively connected to the feedback sensors of the transport means 103 and other feedback sensors as well. The feedback sensor may provide the optical decision maker 105 with digital data to ensure smooth and proper functioning of the automated segregation unit 100. For example, the optical decision maker 105 may stop the automated segregation unit 100 based on the inputs received from the feedback sensors (in cases of any component malfunctions such as VFD of Motor). In an embodiment, the optical decision maker 105 may stop the driving unit of the transport means 103 based upon the inputs of the feedback sensors when a damage to the transport means 103 is detected.

The optical decision maker 105 may be integrated with a first vision system 105′. The first vision system 105′ helps to scan the mixed waste stream. The first vision system 105′ of the automated segregation unit 100 may include without limitation, an AI powered vision system, NIR/IR camera-based vision system or any equivalent system which may include identification of mixed waste moving on the transport means and processing capabilities.

The first vision system 105′ may scan the mixed waste stream at a pre-defined frame rate and/or scanning rate in real-time. The pre-defined frame rate may be defined as the number of frames captured by the first vision system 105′ per unit time. The pre-defined scanning rate may be defined as scanning mixed/residual/rejected waste stream laid over a unit length of the transport means 103 per unit time. The pre-defined frame/scanning rate may range between 1 frame per second to 20 frame per second. The first vision system 105′ may have a field of view ranging from 1 m to 10 m. In an exemplary embodiment, the first vision system 105′ scans the mixed waste stream disposed till 8 meters from the optical decision maker 105 over the transport means 103 at a scanning rate of 2 frames per second.

The first vision system 105′ may create a material profile based on one or more pre-defined identity parameters. In an exemplary embodiment, the pre-defined identity parameter includes the type, mass, dimensions, color, shape, texture, spectrum, etc. of the waste stream scanned by the first vision system 105′. The material profile may include a computed graph and/or a computed data matrix. The first vision system 105′ may be equipped with a database which stores one or more standard profiles/classifiers in one or more look-up tables. The standard profiles may correspond to the profiles of standard materials such as polymers like, PP, PET, HDPE, LDPE, PS, paper, glass, metals, multilayer packaging, cardboard, etc. The standard profiles may contain pre-configured values of the one or more pre-defined identity parameter. Each standard profile may be pre-configured with the one or more pre-defined identity parameters for one to one comparison between the identity parameters of the standard profile and the material profile (further described below).

In addition to the identity parameters described in the present invention, parameters may be added/modified based on the objects to be segregated. For example, the food industry may use parameters corresponding microbial load of food items and the mining industry may use parameters corresponding to different isotopes of various elements/minerals, etc.

Further, the standard profile may be updated and/or added via material profiles accumulated (or historical data) during operation of the unit 100. The unit 100 may include a machine learning module capable to automatically learn and update the look up table containing the standard profiles.

In addition to the identity parameters described above, the identity parameters of the standard profiles and/or the material profiles may include chemical, physical characteristic property including but not limited to color, volume, size, etc. Chemical characterization/identification may be done using electromagnetic (EM) spectrum (0.0001 nm to 100 m) including but not limited to Gamma, X Rays, NIR (Near Infrared), IR (Infrared), Visible Spectrum/hyperspectral/spectral, Radio Waves, etc. The absorption, transmittance, florescence or a combination thereof of the waste stream after scanning the waste stream via one or more wavelengths of the EM spectrum may correspond to characteristic values used corresponding to pre-defined materials. The said characteristic values and corresponding and pre-defined materials may be stored in the one or more look-up tables.

Additionally and/or optionally, the optical decision maker 105 may prompt the user to confirm the identity of the waste stream scanned by the first vision system 105′.

The first vision system 105′ also includes a processor which compares each of the identity parameter of the material profile of the wastes in the mixed waste stream with the one or more look-up tables containing the one or more standard profiles to identify the different kinds of materials in the mixed waste stream. For example, the first vision system 105′ may compare the material profile of the wastes in the mixed waste stream with the one or more look-up tables containing the one or more standard profiles to determine a score for each of the standard profiles. The standard profile with the highest score after comparison may corresponds to the closest identity of the material.

Alternatively or additionally, the first vision system 105′ compares the absorption, transmittance and/or florescence of the wastes in the mixed waste stream with the one or more look-up tables containing the characteristic values corresponding to pre-defined materials to identify the different kinds of materials in the mixed waste stream.

Such comparison between the profile generated by the first vision system 105′ and the look-up tables containing the standard profiles helps the optical decision maker 105 to categorize the recyclable materials present in the mixed waste stream. The optical decision maker 105 also prioritizes the ejection of the categorized recyclable materials based upon the same. The priority may be decided upon a pre-defined priority parameter such as economic valve and/or abundance, etc. Other pre-defined parameter based on user requirements are within the scope of the teachings of the present invention.

Alternatively, the optical decision maker 105 may include one or more pre-defined look-up table defining an order of priority of ejection based upon a composition profile of the mixed waste stream. For example, a user may configure the one or more pre-defined look-up table with instruction to eject glass and then plastic if composition of the mixed waste stream contains more than 50% glass.

Additionally and/or optionally, the optical decision maker 105 may prompt the user to prioritize the ejection of the categorized recyclable materials.

The optical sorter(s) 107 may be functionally coupled to the optical decision maker 105. In an embodiment, the categorized recyclable materials to be ejected as prioritized by the optical decision maker 105 is digitally communicated to the optical sorter(s) 107. In an alternate embodiment, the optical decision maker 105 randomly assigns/allocates the ejection of the categorized recyclable materials to the optical sorter(s) 107 without any priority.

In an embodiment, the optical decision maker 105 communicates one category of recyclable materials to be segregated to one optical sorter 107. In another embodiment, the optical decision maker 105 communicates one category of recyclable materials to be segregated to multiple optical sorters 107, where the category of recyclable materials is same for each and every optical sorter 107. In yet another embodiment, the optical decision maker 105 communicates one category of recyclable materials to be segregated to multiple optical sorters 107 each, where the category of recyclable materials is different for each and every optical sorters 107. In another embodiment, the optical decision maker 105 communicates multiple category of recyclable materials to be segregated to one optical sorter 107 in an order of precedence. In another embodiment, the optical decision maker 105 communicates multiple categories of recyclable materials to be segregated to multiple optical sorters 107 each.

The optical sorter 107 of the automated segregation unit 100 is utilized for physically segregating the mixed waste stream based upon the instructions of the optical decision maker 105. The unit 100 may include at least one optical sorter 107.

The optical sorter 107 may be integrated with a second vision system 107′, equivalent to that of the optical decision maker 105. The second vision system 107′ of the optical sorter 107 may be configured to scan the mixed waste stream and identify the categorized recyclable material(s) to be ejected by it based upon the instructions of the optical decision maker 105. Additionally/optionally, the second vision system 107′ of the optical sorter 107 may help to determine the position of the categorized recyclable material on the transport means 103 based upon a virtual x-y coordinate plane. The second vision system 107′ may also be paired with a processor or equivalent computing means to make decisions based upon analysis of the scans given by the second vision system 107′. The second vision system 107′ may have access to the one or more look-up tables of the first vision system 105′ to help the second vision system 107′ to precisely identify and determine the position (for example, via a virtual x-y coordinate plane on the transport means 103) of the categorized recyclable material on the transport means 103.

The optical sorter 107 may be additionally provided with at least one ejection means. The ejection means may be any conventional unit capable of ejecting the categorized recyclable material(s). The ejection means may include any mechanical unit with suction and/or ejection abilities. For example, the ejection means may be in the form of a manifold, disposed parallel to the transport means 103, including a plurality of pneumatic air valves. Each of the pneumatic air valves of the manifold may be mapped to the virtual x-y coordinate plane on the transport means 103 which help to precisely eject the recyclable material(s) from the transport means 103 to the respective storage unit 109. The ejection means may be controlled by the optical sorter 107 enabling it to precisely eject the categorized recyclable material without disturbing the surrounding mixed waste stream. For example, the optical sorter 107 may communicate the x-y coordinate of an identified material to be ejected to the ejection means such that the ejection means may activate the corresponding mapped pneumatic air valve to precisely eject the said material from the transport means 103 to the respective storage unit 109. It should be noted that though the present invention is described using pneumatic air valves, other apparatus known in the art that are capable of precisely ejecting a material may also be used like mechanical sorters such as robotic arms or equivalent mechanical structures. Further, the second vision system 107′ of the optical sorter 107 may control the opening and closing of the storage units 109 to capture/guide the recyclable material(s) into the respective storage units 109.

In an alternate embodiment, the optical sorter 107 may not have its own vision system and completely relies on digitally communicated inputs from the optical decision maker 105 to identify and precisely eject the recyclable material. In another embodiment, the optical sorter 107 and the optical decision maker 105 may form a single integrated unit.

The storage units 109 provided with the present invention may be any conventional storage space/container known in the art. The storage units 109 may be used to store the recyclable material as ejected and separated by the unit 100. Each storage unit 109 may be dynamically designated for storing a particular categorized recyclable material.

Each storage unit 109 may or may not be provided with a capture mechanism 109′. In an embodiment, all the storage units 109 include respective capture mechanism 109′. Alternately, a pre-defined number of storage units 109 out of all the storage units 109 may be provided with the capture mechanism 109′.

The capture mechanism 109′ may include but not limited to pivoting flaps, slidable doors, rocking panels, pneumatic ejection, etc. In an embodiment, the capture mechanism 109′ includes pivoting flaps. The capture mechanism 109′ may help to open and close the storage unit 109. The capture mechanism 109′ may also aid in collecting/guiding the particular categorized recyclable material into the respective storage unit 109 from the transport means 103. The capture mechanism 109′ may be controlled by the optical sorter(s) 107 and/or the optical decision maker 105.

As an embodiment shown in FIG. 1, the unit 100 includes one feeder 101, a first transport means 103, a second transport means 103a, a third transport means 103b, one optical decision maker 105, one optical sorter 107 and a plurality of storage units 109.

The feeder 101 is configured to provide the unit 100 with the mixed waste. The first transport means 103 forms a loop which first transports the mixed waste stream from the feeder 101 to the optical decision maker 105 and to the optical sorter 107. Subsequently, the first transport means 103 transports the residual waste stream from the optical sorter 107 back to the optical decision maker 105 and to the optical sorter 107. The second transport means 103a may transport the ejected recycled materials from the optical sorter 107 to its respective storage unit 109. The third transport means 103b may transport the rejected waste stream from the optical sorter 107 to the dumping unit. Optionally/additionally, the third transport means 103b may be provided with another optical decision maker (not shown).

The unit 100 as elaborated above may function in a pre-defined manner as shown in FIG. 1a. Once the feeder 101 starts to feed the mixed waste to the unit 100 via the transport means 103, the unit 100 commences its operation. In an embodiment, the mixed waste stream includes different types of solid dry waste. Before the start of the operation, a user may configure one or more parameters of the automated segregation unit 100 which would determine the functioning of the unit 100. For, example, the user chooses to segregate only the white/transparent bottles present in the mixed waste stream.

At step 10, the first vision system 105′ scans the mixed waste stream on the transport means 103 and prepares the material profile of the waste in the mixed waste stream dynamically in real-time to identify the different types of waste in the fed mixed waste stream. For example, at a given time, the first vision system 105′ identifies that the mixed waste stream includes glass bottles, plastic bottles and non-recyclable waste. The first vision system 105′ determines that the glass bottles in the mixed waste stream are the most abundant followed by plastic bottles and non-recyclable waste.

At step 10a, the optical decision maker 105 categorizes the mixed waste stream into three categories i.e. transparent glass bottles, transparent plastic bottles and non-recyclable waste. The optical decision maker 105 also sets a priority of ejection of the recyclable materials based upon a specific parameter. For example, the optical decision maker 105 sets the priority of ejection based upon the abundance of the categorized recyclable material. Hence, the transparent glass bottles are the first priority while the transparent plastic bottles are the second priority of ejection.

The optical decision maker 105 communicates the priority of ejection as an instruction to the optical sorter 107.

At step 10b, the optical sorter 107 scans the mixed waste stream for identifying the categorized recyclable materials having the first priority of ejection i.e. the most abundant categorized waste. The identification includes for example, the placement of the categorized waste over the transport means 103 with respect to the virtual x-y coordinate system.

As soon as the said categorized waste is identified and located over the transport means 103, at step 10c, the optical sorter 107 activates its respective ejection means corresponding to the placement of the categorized waste to precisely eject the categorized recyclable material. The ejected waste material is disposed in its respective storage unit 109 via the second transport means 103a. The optical sorter 107 instructs the capture mechanism 109′ of the respective storage unit 109 to collect the ejected categorized recyclable material (or segregated waste) from the second transport means 103a.

At step 10d, the categorized recyclable material having the first priority i.e. the transparent glass bottles is ejected into the storage unit 109 via the second transport means 103a while the non-recyclable (rejected) waste stream is diverted to the third transport means 103b for composting.

At step 10e, the mixed (residual) waste stream having the remaining categories of waste may be looped again for ‘n’ number of times following the same procedure to finally segregate recyclable plastic bottles. Alternatively, the mixed (residual) waste stream may be looped ‘n’ number of times until a rejected waste stream is obtained. The decision to loop the categories of waste may be decided by the optical decision maker 105 on the basis of the composition of the mixed waste stream at any given time.

Alternatively, the remaining categories of waste may be passed through ‘x’ number of optical sorters 107 before looping.

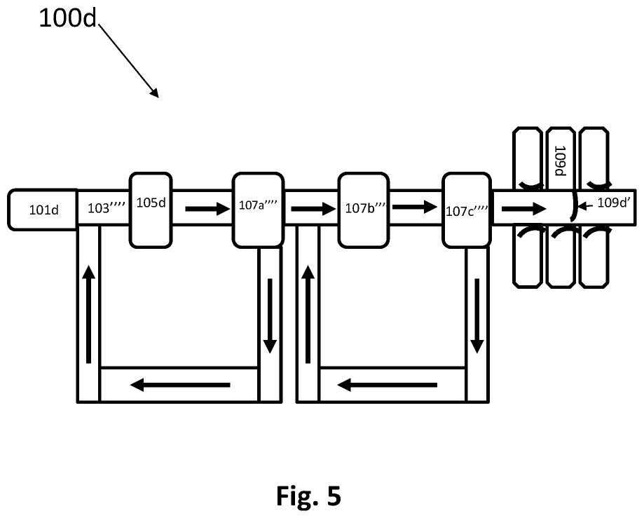

Alternatively, the residual and/or rejected waste stream of a waste segregation unit may be looped one or more times through separate transport means. In an embodiment, the residual waste stream of the waste segregation unit 100d (depicted in FIG. 5) is looped on a transport means 103″″ for a first time between the first optical sorter 107a″″ and an optical decision maker 105d and for a second time between third optical sorter 107c″″ and the second optical sorter 107b″″. The unit 100d also includes a feeder 101d and a plurality of storage units 109d with capture mechanism 109d′.

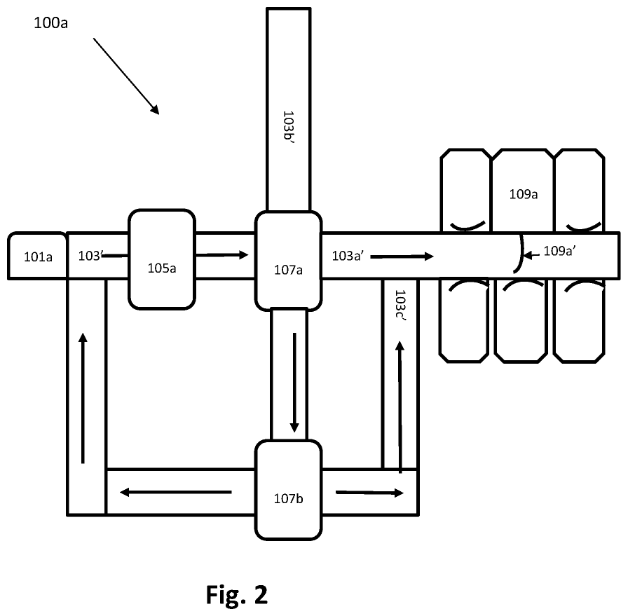

Alternate to the above embodiment, FIG. 2 depicts an automated segregation unit 100a. As shown in FIG. 2, the unit 100a includes one feeder 101a, a first transport means 103′, a second transport means 103a′, a third transport means 103b′, a fourth transport means 103c′, a optical decision maker 105a, a first optical sorter 107a, a second optical sorter 107b and a plurality of storage units 109a with capturing means 109a′.

The feeder 101a is configured to provide the unit 100a with the mixed waste. The first transport means 103′ forms a loop which first transports the mixed waste stream from the feeder 101a to the optical decision maker 105a and to the first optical sorter 107a. Subsequently, the first transport means 103′ transports the residual waste stream from the first optical sorter 107a to the second optical sorter 107b and further to the optical decision maker 105a. The second transport means 103a′ may transport the recycled materials from the first optical sorter 107a to its respective storage unit 109a. The third transport means 103b′ may transport the rejected waste stream from the first optical sorter 107a to the dumping unit. The fourth transport means 103c′ may transport the recycled material from the second optical sorter 107b to its respective storage unit 109a.

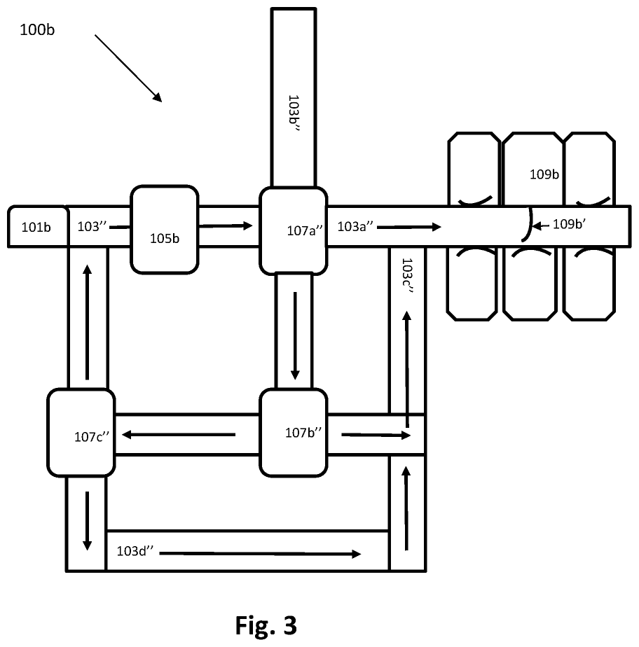

In yet another embodiment as depicted in FIG. 3, the unit 100b includes one feeder 101b, a first transport means 103″, a second transport means 103a″, a third transport means 103b″, a fourth transport means 103c″, a fifth transport means 103d″, a optical decision maker 105b, a first optical sorter 107a″, a second optical sorter 107b″, a third optical sorter 107c″ and a plurality of storage units 109b with capture mechanism 109b′.

The feeder 101b is configured to provide the unit 100b with the mixed waste. The first transport means 103″ forms a loop which first transports the mixed waste stream from the feeder 101b to the optical decision maker 105b and to the first optical sorter 107a″. Subsequently, the first transport means 103″ transports the residual waste stream from the first optical sorter 107a″ to the second optical sorter 107b″ and further to the third optical sorter 107c″. The residual waste stream is finally recirculated to the optical decision maker 105b. The second transport means 103a″ may transport the recycled materials from the first optical sorter 107a″ to its respective storage unit 109b. The third transport means 103b″ may transport the rejected waste stream from the first optical sorter 107a″ to the dumping unit. The fourth transport means 103c″ may transport the recycled material from the second optical sorter 107b″ to its respective storage unit 109b. The fifth transport means 103d″ may transport the recycled material from the third optical sorter 107c″ to its respective storage unit 109b.

As evident from the above, the automatic segregation units 100a, 100b include plurality of optical sorters. The working of the automatic segregation units 100a, 100b may be similar to the working of the automatic segregation units 100. In case of multiple optical sorters as shown in FIG. 2 and FIG. 3, the mixed waste stream having the remaining categories of recyclable materials may be sequentially ejected by additional optical sorters to finally segregate all the recyclable materials.

The presence of multiple optical sorters is very useful in case the mixed waste stream includes more number of categorized recyclable materials. However, in cases where the number of categorized recycle materials is less than the number of optical sorters, the optical decision maker may have a provision to disable or inactivate the working of the remaining optical sorters and respective transport means.

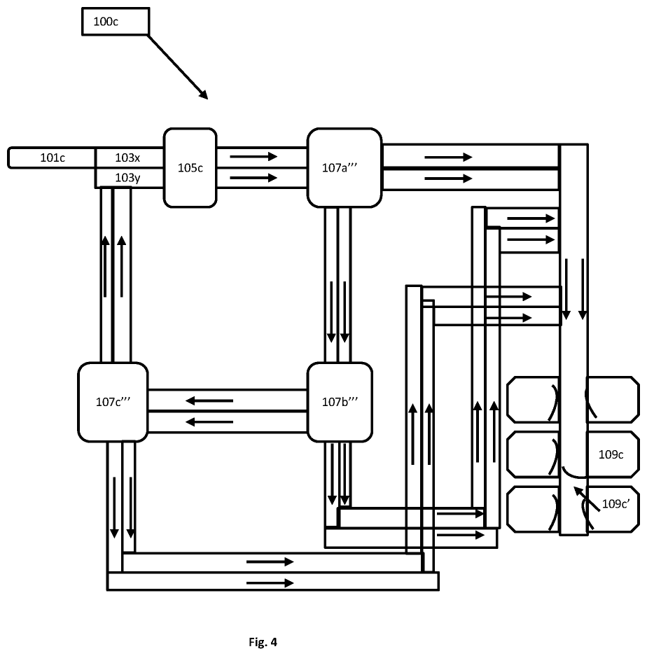

FIG. 4 shows another embodiment of FIG. 3. The unit 100c includes one feeder 101c, two transport means 103x, 103y, an optical decision maker 105c, a first optical sorter 107a′″, a second optical sorter 107b″, a third optical sorter 107c′″, and a plurality of storage units 109c with capturing means 109c′. The unit 100c may be structurally similar to the unit 100b except for the presence of two parallel transport means 103x and 103y for carrying the mixed waste stream. The feeder 101c may feed the unit 100c via two transport means 103x, 103y which carry the mixed waste stream simultaneously for segregation of recyclable waste.

Alternately, one transport means 103x or 103y may be operational in series. For example, once the mixed waste stream is segregated by the loop formed by one transport means 103x, the mixed waste stream may be circulated on the other transport means 103y. Such a provision may be helpful in instances where the mixed waste stream includes more number of categories of waste, thereby increasing efficiency and saving a lot of time.

The foregoing description of preferred embodiments of the present disclosure provides illustration and description, but is not intended to be exhaustive or to limit the disclosure to the precise form disclosed. Modifications and variations are possible in light of the above teachings or may be acquired from practice of the disclosure.

The scope of the invention is only limited by the appended patent claims. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

We claim:

1. An automated segregation unit (100), comprising:
one or more feeders (101) to receive a stream of mixed objects to be segregated by the unit (100);
one or more optical decision makers (105) which controls the unit (100),
wherein, the optical decision maker (105) is integrated with a first vision system (105′) configured to categorize one or more materials present in the stream of mixed objects on the basis of one or more identity parameters;
one or more optical sorters (107) functionally coupled to the optical decision maker (105), the optical sorter (107) configured to physically segregate the categorized one or more materials from the stream of mixed objects;
a plurality of storage units (109) to collect respective categories of segregated objects; and
a plurality of transport means (103) operationally coupled to the one or more feeders (101), one or more optical decision makers (105), one or more optical sorters (107) and the plurality of storage units (109) for transporting at least one of the one or more materials and/or segregated objects between each other;
wherein, the one or more optical decision makers (105) instructs the one or more optical sorters (107) to eject one or more category of segregated objects to its respective storage unit (109).

2. The automated segregation unit (100) as claimed in claim 1, wherein the feeder (101) includes a feeding rate.

3. The automated segregation unit (100) as claimed in claim 1, wherein the optical decision maker (105) acts based upon a data given by a plurality of feedback sensors, thereby, in case of any malfunction, the user is not required to manually identify the cause and switch off the entire plant.

4. The automated segregation unit (100) as claimed in claim 3, wherein the feedback sensors include near infrared sensors, X-ray sensors, Red Green Blue visible spectrum/hyperspectral/spectral sensors/cameras or a combination thereof.

5. The automated segregation unit (100) as claimed in claim 3, wherein the feedback sensors are operatively coupled to the transport means (103).

6. The automated segregation unit (100) as claimed in claim 1, wherein the first vision system (105′) scans the mixed waste at a pre-defined frame rate and/or scanning rate in real-time and create a material profile.

7. The automated segregation unit (100) as claimed in claim 6, wherein the first vision system (105′) compares the material profile of the objects in the mixed objects with the one or more look-up tables containing one or more standard profiles to identify the different kinds of materials in the mixed objects.

8. The automated segregation unit (100) as claimed in claim 1, wherein the optical decision maker (105) prioritizes the ejection of the categorized materials based on a pre-defined priority parameter such as economic value and/or abundance.

9. The automated segregation unit (100) as claimed in claim 1, wherein the optical sorters (107) includes at least one ejection means in the form of a mechanical unit with suction and/or ejection abilities.

10. The automated segregation unit (100) as claimed in claim 1, wherein the optical sorters (107) includes at least one ejection means in the form of a manifold.

11. The automated segregation unit (100) as claimed in claim 10, wherein the manifold includes a plurality of pneumatic air valves disposed parallel to the transport means (103).

12. The automated segregation unit (100) as claimed in claim 1, wherein the storage units (109) includes a capture mechanism (109′) which aids in collecting/guiding one or more category of objects into the respective storage unit (109) from the transport means (103).

13. The automated segregation unit (100) as claimed in claim 1, wherein the transport means (103) includes a transport rate.

14. The automated segregation unit (100) as claimed in claim 13, wherein the transport rate is controlled based upon density and/or volume per unit area of the mixed objects present on the transport means (103).

15. The automated segregation unit (100) as claimed in claim 6, wherein the first vision system (105′) compares the absorption, transmittance and/or florescence of the objects in the mixed object with the one or more look-up tables containing a characteristic value corresponding to pre-defined materials to identify the different kinds of materials in the mixed object.

16. The automated segregation unit (100) as claimed in claim 1, wherein, the optical sorter (107) is integrated with a second vision system (107′) configured to identify the categorized material before segregation.

17. A method of operating the automated segregation unit (100), the method comprises:
scanning a stream of mixed objects by one or more optical decision maker (105);
categorizing the mixed objects by the optical decision maker (105) based upon one or more predefined identity parameters;
prioritizing the categorized objects from step b by the optical decision maker (105) based upon one or more predefined priority parameter;
instructing one or more optical sorter (107) to eject the prioritized objects from step c, the instruction being communicated by the optical decision maker (105);
ejecting each category of objects from the stream of mixed objects by at least one ejection means; and
collecting respective categories of ejected objects from step e by a plurality of storage units (109).

18. A method of operating the automated segregation unit (100), the method comprises:
scanning a stream of mixed objects by one or more optical decision maker (105);
categorizing the mixed objects by the optical decision maker (105) based upon one or more predefined identity parameters;
prioritizing the categorized objects from step b by the optical decision maker (105) based upon one or more predefined priority parameter;
instructing one or more optical sorter (107) to eject the prioritized and categorized objects from step c, the instruction being communicated by the optical decision maker (105);
ejecting one or more category of objects from the stream of mixed objects by at least one ejection means;
collecting respective categories of ejected objects from step e by a plurality of storage units (109); and
looping remaining category of objects via a plurality of transport means (103) to eject the remaining category of objects in the plurality of storage units (109) by following step a to f.

19. The method as claimed in claim 18-19, wherein before ejecting the one or more categorized objects the optical sorter (107) scans the stream of mixed objects to identify the categorized mixed objects.

20. The method as claimed in claim 18-19, wherein the identity parameter includes type, mass, dimensions, color, shape, volume, texture, size, absorption, transmittance, florescence or a combination thereof.

21. The method as claimed in claim 18-19, wherein the priority parameter includes economic value and/or abundance.
